(19) United States
(12) Patent Application Publication
(10) Pub. No.: US 2013/0020404 A1
(43) Pub. Date: Jan. 24, 2013

(54) Mobile Outdoor Mister

(71) Applicant: Roy F. Knight, Oklahoma City, OK (US)

(72) Inventor: Roy F. Knight, Oklahoma City, OK (US)

(21) Appl. No.: 13/185,809

(22) Filed: Jul. 19, 2011

(51) Int. Cl. B05B 13/00

(52) U.S. Cl. 239/128

(57) ABSTRACT

A mobile outdoor mister includes a chassis with at least one axle and wheels operably connected thereto at least one water tank operably disposed on said chassis containing water, a water chiller operably connected to said tank in a manner to chill the water, a spray conduit having spraying end of rigid conduit configured with plurality of spray nozzles spaced therealong and having a cross bar connected to an elongated flexible conduit end, a pump having a pump inlet and a pump outlet causing forced water flow from the tank through, and a power generator operably connected to the pump and the water chiller such that the water flows through the chiller and through and out the spray conduit as a mist.

### BACKGROUND

1. Field of Invention

The present invention relates to air humidifying apparatus for use particularly in hot, dry, outdoor environments. More particularly, the invention relates to a large scale mobile outdoor mister with a chiller incorporated therewith.

2. Related Art

Water evaporation is effective as a coolant when ambient air has low humidity. Comfort levels are enhanced in extremely dry environments by elevating to moderately dry relative humidity. Typically, for large scale application, there is a required water supply from a lake or ground.

Misting devices have been used for air conditioning of outdoor environments. However, the misting devices of the prior art are not suitable for large scale areas in extremely hot environments. This is particularly true in desert type areas where water is scarce or not practically available.

Further, the prior systems lack capability to be readily employed into an outdoor work environment without interference to their tasks at hand. They are also ineffective in that they do not provide a desired coverage of the misting at a given area which will be varied in the work environment. Such systems are unsuitable for use in many outdoor locations because they require a large source of water under pressure or are awkward to relocate and/or to store when not in use.

There remains a need for a portable outdoor mister that has real application in extremely hot outdoor work environments where little or no ground water is present. It is also desirable to have a mister which is easy to deploy in such environments in an unobtrusive manner to the workers yet can easily migrate with locations of the worker.

### SUMMARY

It is an object to improve misting devices.

It is another object to provide a mobile mister which is employed in extremely hot outdoor environments where there is no fixed water supply available.

It is another object to provide a mister which is easily moved at the site to follow with the worker's task as opposed to having the worker leave their work station to get misted all occurring in an unobtrusive manner.

The present invention provides a portable outdoor mister which meets the need for extremely hot work environments which do not have a readily accessible water reservoir thereby. The mister includes a chassis with at least one axle and wheels operably connected thereto; at least one large water tank operably disposed thereon for containing water, a water chilling apparatus operably connected to the tank in a manner to chill the water and which is preferably on the chassis, a spray conduit having spraying end configured with plurality of spray nozzles spaced therealong connected to an elongated flexible end; a pump having a pump inlet and a pump outlet causing forced water flow from the tank through the chilling apparatus and through and out the spray conduit; and a power generator operably connected to the pump.

Preferably, the spraying end includes rigid conduit and a cross member such that the spraying end can be laid on the ground and maintain the nozzles in a fixed direction with the spray upward from the ground. The flexible end can include an elongated hose which can for example be threadably connected to the spraying end.

### DRAWINGS

These and other features, aspects, and advantages of the present invention will become better understood with reference to the following description, appended claims, and accompanying drawings, where:

FIG. 1 is a perspective view of according to the present invention;

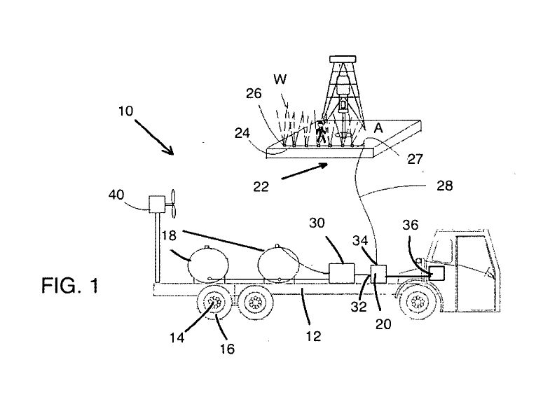

FIG. 2 is a schematic diagram of the mister of FIG. 1;

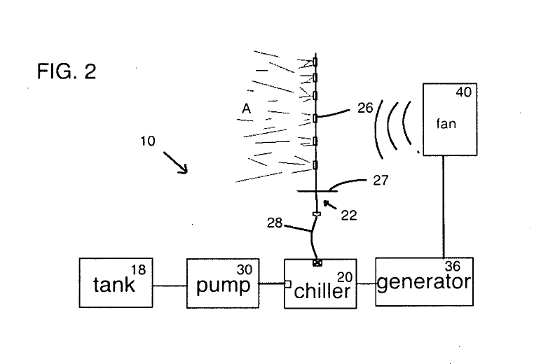

FIG. 3 is another embodiment of the invention; and

FIG. 4 is a schematic of the mister of FIG. 3.

### DETAILED DESCRIPTION OF PREFERRED EMBODIMENT

The present invention is directed to a mobile outdoor mister for cooling extremely hot environments such as rough necks working in the oil field in desert like conditions and is generally designated by the numeral 10. It is common for temperatures to exceed 100 degrees Fahrenheit in the oil and gas fields. With reference to the drawings, an exemplary mister 10 according to the present invention includes a chassis 12 with at least one axle 14 and wheels 16 operably connected thereto.

At least one (and preferably a plurality) large water tank 18 is operably disposed on the chassis 12 for containing water W. The tank 18 can preferably hold several hundred gallons (e.g., 500 gallons). Here, tanks 18 have a 2″ fitting connected to pump 30 with a 1″ fitting which in turn connects to chiller 20 having a ⅜″ fitting.

A water chiller 20 is operably connected to the tank 18 in a manner to chill the water W and is preferably on operably disposed the chassis 12. In this regard, a Peltier cooler can be employed wherein electric power is used to generate a temperature difference between the two sides of the device. Optionally, a freezer with copper coiling can be employed to reduce the temperature of the water. A spray conduit 22 has a spraying end 24 configured with plurality of spray nozzles 26 spaced therealong. A cross member 27 is rigidly connected to the spraying end 24 which can be of a rigid conduit material. In this way, when disposed on a ground surface, the nozzles 26 can be maintained in a fixed direction. Connected to this is an elongated flexible end 28.

A pump 30 has a pump inlet 32 and a pump outlet 34 causing forced water flow from the tank 18 through the chiller 20 and through and out the spray conduit 22. A portable gas powered generator 36 is operably connected to the pump 30.

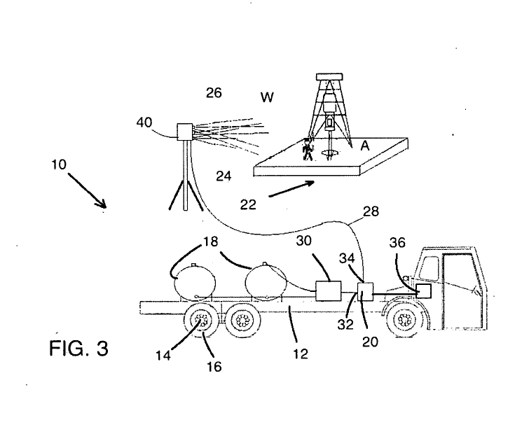

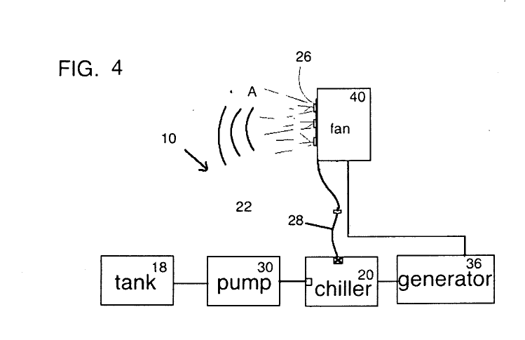

The mister 10 dispenses water W in the form of a mist for the facilitation of evaporative cooling of an area A. The pump 30 can be configured to selectively adjust the pressure under which the water W is dispensed. A fan 40 can preferably be movably mounted with the bracket for blowing air towards the area A to further cool the air and disperse the water W over the worker. As seen in FIGS. 3 and 4, the spray conduit 22 can be fixed to part of the fan 40.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A mobile outdoor mister, which includes:
a chassis with at least one axle and wheels operably connected thereto;
at least one water tank operably disposed on said chassis containing water;
a water chiller operably connected to said tank in a manner to chill the water;
a spray conduit having spraying end of rigid conduit configured with plurality of spray nozzles spaced therealong and having a cross bar connected to an elongated flexible conduit end;
a pump having a pump inlet and a pump outlet causing forced water flow from the tank through the chiller and then through and out the spray conduit as a mist; and
a power generator operably connected to the pump and the water chiller.

2. The mobile outdoor mister of claim 1, wherein said water chiller is disposed on the chassis.

3. The mobile outdoor mister of claim 1, wherein the spray conduit is configured such that when the spraying end is laid on the ground the nozzles are fixed to spray upward from the ground.

4. The mobile outdoor mister of claim 1, wherein said elongated flexible conduit end is threadably connected to the spraying end.

5. The mobile outdoor mister of claim 1, which includes a fan movably connected to the chassis for blowing air towards the mist.
